(19) United States
(12) Patent Application Publication
(10) Pub. No.: US 2006/0219956 A1
(43) Pub. Date: Oct. 5, 2006

(54) Device and method for generating characteristic radiation or energy

(76) Inventors: Joshua J. Bergman, Alpharetta, GA (US); Richard R. Brauckman, Cumming, GA (US); Jack C. White, Alpharetta, GA (US)

Correspondence Address: KNOBLE YOSHIDA & DUNLEAVY, LLC, Eight Penn Center, Suite 1350, 1628 John F. Kennedy Blvd., Philadelphia, PA, 19103, US

(21) Appl. No.: 11/075,495

(22) Filed: Mar. 9, 2005

(51) Int. Cl. G21G 4/00

(52) U.S. Cl. 250/493.1

(57) ABSTRACT

A method and device for producing characteristic radiation is disclosed. A beta radiation emitting material is coupled with a converter material, which could be any of a pure element, an alloy, a compound, a composition or mixture. The beta radiation emitting material emits beta radiation, which interacts with the converter material to produce characteristic radiation. The device can be used for brachytherapy. Also disclosed is a power generation device, which further includes a second converter material for converting characteristic radiation to heat or electricity.

### BACKGROUND OF THE INVENTION

1. Field of the Invention

The invention relates to the production of characteristic radiation or energy. In particular the invention relates to a device and a method for producing characteristic radiation for various uses, including, among others, energy generation and brachytherapy.

2. Description of the Related Technology

Brachytherapy is a field of medicine that utilizes radiation to treat ailments and physical disorders. Typically the radiation treatment is administered to the patient using a radiation-emitting device that is located in close proximity to the treatment location. The radiation is emitted from the source directly to the treatment location, unlike external beam radiotherapy, where radiation typically traverses normal tissue in order to reach the treatment location. This results in decreased toxicity and/or allows the use of a larger radiation dose. Brachytherapy can be used intra-operatively in situations where surgery is not possible or not optimal, or in situations where prior dose-limiting external radiotherapy has already been given. Combined approaches of surgery and brachytherapy can often improve on the results, as compared to surgery or radiotherapy alone.

In brachytherapy, the type of radiation used in the treatment is important. Some types of radiation are too intense to use during some treatments, while other types of radiation are too weak to be effective.

There are three general types of radiation; alpha radiation, beta radiation and gamma radiation. Alpha particles are relatively slow and heavy. Alpha radiation has a low penetrating power. Beta particles are fast, light, and have medium to high penetrating power. Gamma rays have no mass and no charge. Gamma rays have a high penetrating power. X-rays can have the same magnitude of energy and intensity as gamma radiation.

Out of the three types of radiation listed above, beta radiation and gamma radiation are suitable for use in brachytherapy due to their penetrating power. Important features of the radioactive source are the half life and intensity of the radiation produced. It is important when using a radioactive source that it has a sufficiently long half-life with reasonable penetrating power. Also, it is often desirable that at least for implanted sources, the half-life of the radioactive material should not be too long so that the radioactivity will decay to a minimal amount within a reasonable time period. For example, palladium-103 with a half-life of about 17 days is an excellent brachytherapy source since the half-life is sufficiently long to permit shipping of the source to the treatment location without a major loss of activity, while at the same time the palladium-103 decays to ⅛^{th} its original activity in about 51 days.

X-rays are an effective form of radiation for use in brachytherapy. There are several ways to generate x-ray radiation, including at least bremsstrahlung and the generation of characteristic radiation.

Bremsstrahlung occurs when fast electrons interact in matter. Part of the energy of the electrons is converted into electromagnetic radiation. Specifically, the electrons are accelerated by the attraction of the nuclear coulomb force of a positively charged atomic nucleus. As the electrons passes near the nucleus, deceleration occurs resulting in the radiative loss of photons, i.e. the bremsstrahlung spectrum. The fraction of the energy of the electrons that is converted into bremsstrahlung increases with increasing electron energy and is largest for materials of high atomic number. Typically, bremsstrahlung is used in the production of x-rays from conventional x-ray tubes. FIG. 1 shows the bremsstrahlung energy spectrum emitted in the forward direction by 5.3 MeV electrons incident on an Au—W target. A 7.72 g/cm² aluminum filter was also present. The shape of the spectrum is typical for bremsstrahlung radiation. The emission of low-energy photons predominates and the average photon energy is a small fraction of the incident energy.

Characteristic radiation is produced when orbital electrons in an atom are ejected from their normal energy state by some excitation process. The atom may exist in an excited state for a short period of time. There is a natural tendency for the electrons to rearrange themselves so that the atom returns to its lowest energy state. The energy released by the transition from the excited state to the lowest energy state takes the form of a characteristic x-ray photon whose energy is determined by the energy difference between the initial and final energy states. If a vacancy is created in the K-shell of an atom, then a characteristic K x-ray is released when an electron fills the vacancy. If that electron comes from the L shell then a Kα photon is produced whose energy is equal to the difference in binding energies between the K and L shells. If the electron comes from the M shell then a Kβ photon is produced with a slightly larger energy. The maximum K-series photon is produced when a free or unbound electron fills the vacancy and the corresponding energy is then simply given by the K shell binding energy. Vacancies created in outer shells by the filling of a K shell vacancy are subsequently filled with the emission of L, M, etc. series characteristic x-rays.

FIGS. 2a through 2e show the typical interactions experienced by electrons impinging on a target material. In FIG. 2a, the electron undergoes ionization losses resulting in the production of heat and secondary electrons, also called delta rays. FIGS. 2b-2c show the production of bremsstrahlung. The phenomenon illustrated by FIG. 2b has been previously described. FIG. 2c shows the rare occurrence of the electron stopping completely in one collision, producing a photon equal to the initial electron energy. FIG. 2d depicts the production of characteristic radiation as an incident electron ionizes the sample atom by ejecting an electron from an inner shell (the K-shell, in this case). The ejected electron from the K-shell may then undergo any of the interactions described previously. Alternatively, the excess energy, rather than escaping the atom as characteristic radiation, may be transferred to an orbital electron of the same atom. This electron, called an Auger electron, shown in FIG. 2e, leaves the atom with an energy equal to the difference of the excess energy and the binding energy of the ejected electron.

In brachytherapy different methods for treating an illness are used. Some uses of characteristic radiation have been proposed for brachytherapy, but not for the direct treatment of a patient.

U.S. Pat. No. 6,099,457 to Good discloses microspheres to be used as radioactive seeds in brachytherapy. A microsphere is disclosed that uses characteristic radiation as an intermediate in the production of bremsstrahlung radiation for treatment purposes. This microsphere includes 10 layers. The first layer is a central microspherical or microfilament core composed of efficient bremsstrahlung producing high Z material such as hafnium, tantalum, tungsten, rhenium, osmium, or uranium. The second layer is a beta-particle kinetic energy coating that slows beta particles before they collide with the bremsstrahlung target material in the central core. The third layer is a beta-particle producing layer. This layer preferably produces beta particles that have kinetic energies between 5 keV and 500 keV. The preferred radioactive beta-particle-producing radionuclides for the third layer are Pd-112, Tm-165, Ni-66, U-237, Er-169, P-33, W-185, S-35, Os-194, H-3, Ru-106, Pb-210, and Sr-90. There is a fourth layer that acts as a diffusion barrier to prevent atomic leakage into the outer seed coats. The fourth layer is made of chromium nitride or titanium nitride. The fifth layer is a K-fluorescent or L-fluorescent target material, which is coated over the diffusion barrier coating. This coating produces low energy x-rays between 5 keV and 60 keV. Preferred materials for the fifth layer are zirconium, molybdenum, palladium, silver, cadmium, indium, tin, antimony, and tellurium. The sixth layer is a secondary bremsstrahlung coating. The seventh layer is an Auger electron target coating. The seventh layer is said to produce Auger electrons as a result of stimulation from bremsstrahlung x-rays produced in the core. The eighth layer is a secondary bremsstrahlung coating composed of a thin layer of high Z material. The ninth layer is an optional marker coat composed of a paramagnetic material such as samarium. The tenth layer is a protective coating designed to protect the other layers. Although this microsphere produces characteristic radiation at the fifth-layer the ultimate goal of this microsphere is to emit therapeutic bremsstrahlung radiation from the eighth layer and thus, the characteristic radiation produced by the fifth layer is converted to bremsstrahlung by one or more of the other layers of the microsphere.

U.S. Pat. No. 6,477,233 to Ribbing et al. discloses a miniature x-ray source. The miniature x-ray source is implanted into the body for treatment of diseases. However, instead of using a beta emitter and a target material, a cathode and anode are used. Electrons are emitted from the cathode and strike an anode made of a high atomic number element. This generates x-rays which are said to be useful for treatment of diseases.

U.S. Pat. No. 6,477,235 to Chornenky et al. discloses using a miniature x-ray source. The x-ray emitting device is used for medical purposes. Instead of a beta emitter, a cathode is used to emit electrons that strike a target material that will then emit characteristic radiation. The proposed target materials are strontium, yttrium, zirconium, niobium, molybdenum, palladium, and silver.

The above methods provide x-ray radiation for treatment, but none of above methods provides a simplified method or device for emitting a substantial proportion of characteristic radiation from a combination of a beta emitter and a converter for a variety of uses including at least brachytherapy and energy storage and generation.

Therefore, there exists a need for providing a method and device for producing therapeutic radiation for use in brachytherapy.

### SUMMARY OF THE INVENTION

Accordingly, it is an object of certain embodiments of the invention to provide a method and device for producing characteristic radiation. In a first aspect, the present invention provides a method for brachytherapy including the steps of emitting beta radiation, and converting the beta radiation to characteristic radiation for use in brachytherapy.

A second aspect of the invention provides a brachytherapy device having a converter material and a radioactive beta-emitter. The beta emitter emits beta radiation which is subsequently converted by the converter material into characteristic radiation.

A third aspect of the invention is a method for producing electricity including the steps of emitting beta-radiation, converting the beta-radiation to characteristic radiation, and converting the characteristic radiation into electricity.

A fourth aspect of the present invention relates to a device for producing electricity including a beta-emitter, a converter for converting beta radiation to characteristic radiation, and a converter for converting characteristic radiation to electricity.

These and various other advantages and features of novelty that characterize the invention are pointed out with particularity in the claims annexed hereto and forming a part hereof. However, for a better understanding of the invention, its advantages, and the objects obtained by its use, reference should be made to the drawings which form a further part hereof, and to the accompanying descriptive matter, in which there is illustrated and described one or more embodiments of the invention.

### BRIEF DESCRIPTION OF THE DRAWINGS

FIG. 1 shows the bremsstrahlung energy spectrum emitted in the forward direction by 5.3 MeV electrons incident on an Au—W target.

FIG. 2a is a diagram depicting an electron undergoing ionizational losses.

FIG. 2b is a diagram of the production of bremsstrahlung radiation.

FIG. 2c is a diagram of the production of bremsstrahlung radiation with electron stopping completely in one collision.

FIG. 2d is a diagram depicting the production of characteristic radiation as an incident electron ionizes the sample atom by ejecting an electron from an inner shell

FIG. 2e is a diagram depicting the production of an Auger electron.

FIG. 3 shows a mathematically modeled thulim-170 energy spectrum at 3.5 cm from the source in water.

FIG. 4a shows the normalized flux of characteristic radiation grouped by energy for a mathematical model of a krypton-85 beta source with 5 microns thick elemental silver converter material.

FIG. 4b shows the normalized flux of characteristic radiation grouped by energy for a mathematical model of a krypton-85 beta source with 15 microns thick elemental silver converter material.

FIG. 4c shows the normalized flux of characteristic radiation grouped by energy for a mathematical model of a krypton-85 beta source with 30 microns thick elemental silver converter material.

FIG. 4d shows the normalized flux of characteristic radiation grouped by energy for a mathematical model of a krypton-85 beta source with 100 microns thick elemental silver converter material.

FIG. 4e shows the normalized flux of characteristic radiation grouped by energy for a mathematical model of a krypton-85 beta source with 500 microns thick elemental silver converter material.

FIG. 4f shows the normalized flux of characteristic radiation grouped by energy for a mathematical model of a krypton-85 beta source with 1000 microns thick elemental silver converter material.

FIG. 4g shows the normalized flux of characteristic radiation grouped by energy for a mathematical model of a krypton-85 beta source with 2000 microns thick elemental silver converter material.

FIG. 5 shows a cross-sectional view of a thulium-170 brachytherapy device.

FIG. 6 shows a thulium-170 brachytherapy device x-ray spectrum.

FIG. 7a shows a model of a P-32 beta emitter and a tin converter brachytherapy device.

FIG. 7b shows a schematic of another embodiment of a device in accordance with the present invention.

FIG. 8 shows a graph of the x-ray spectrum created with a P-32 beta source and a 50-micron thickness of tin.

FIG. 9 shows a photovoltaic cell and source/converter energy source.

FIG. 10 shows a graph of the continuous slowing down approximation (CSDA) range for electrons through silver, gold, and aluminum.

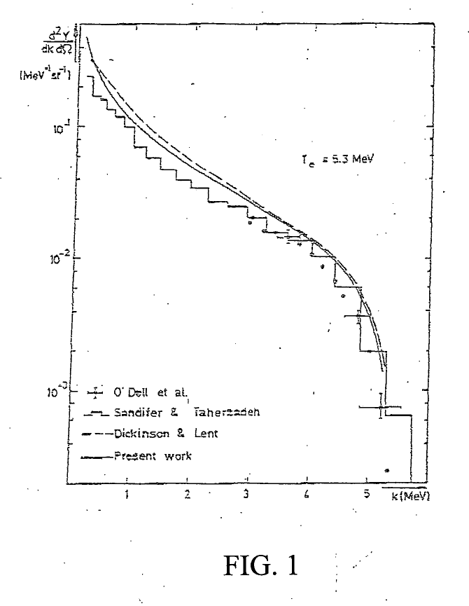

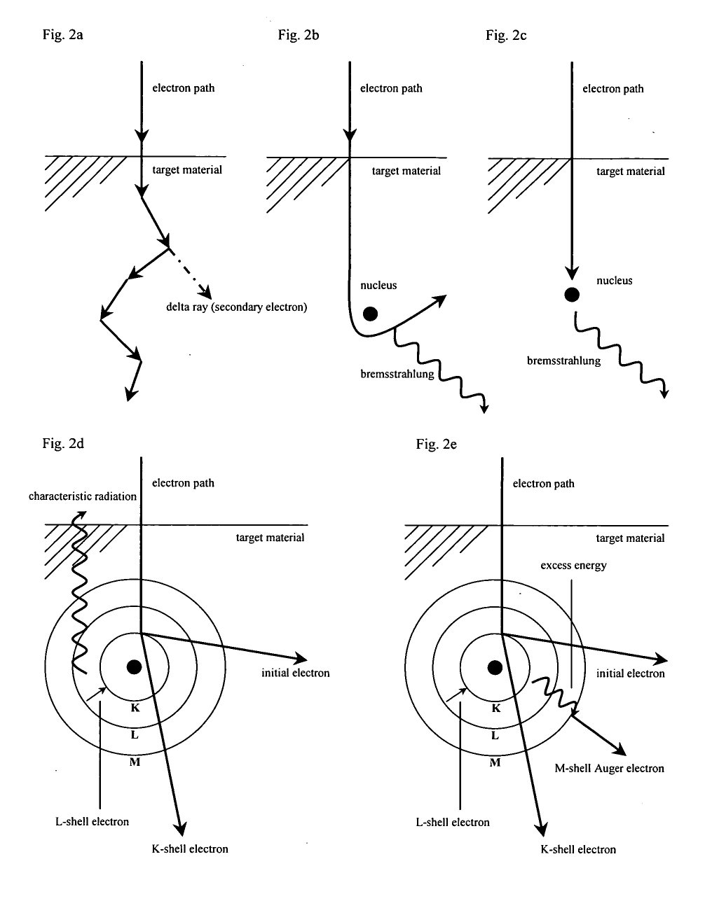

### DETAILED DESCRIPTION OF THE PREFERRED EMBODIMENT(S)

Monte Carlo modeling has shown that a beta-emitting isotope coupled with a relatively high Z “converter” material, which can be a pure element, an alloy, a compound or a composition, creates x-rays, also called characteristic radiation, at, for example, the energy level of the element's K-shell. Beta particles interact with bound electrons around the atoms of the converter material, and the beta particles that have sufficient energy will dislodge an electron from its orbit in the converter material, typically a K-shell electron is dislodged. Subsequently, an electron from a higher shell, such as the L-shell, drops to the lower energy level K shell with the consequence that an x-ray of characteristic radiation is emitted from the converter material.

The quantity and energy of emissions from the converter material are dependent upon the converter material's atomic number, geometry, and density. Choosing an appropriate converter material for an optimized geometry together with a beta emitter with sufficient energy to eject K-shell electrons from the converter material will produce a nearly mono-energetic spectrum of characteristic radiation emitted from the converter material at the K-shell energy. This mono-energetic spectrum is such that it contains, at most, insubstantial amounts of other types of radiation emissions, such as bremsstrahlung.

Any existing beta-emitting radioisotope can be employed in the present invention. Pure or nearly pure beta-emitters are preferable for brachytherapy applications. The table below provides a selection of preferred radioisotopes that can be employed as beta-emitters in the present invention:

TABLE 2
Useful Beta-Emitting Isotopes

| | | | Max. Beta | Avg. Beta |
|---|---|---|---|---|
| Isotope | Half-life | | Energy (keV) | Energy (keV) |
| Thallium-204 | 3.78 | years | 763 | 238 |
| Phosphorus-32 | 14.28 | days | 1710 | 695 |
| Strontium-89 | 50.52 | days | 1492 | 583 |
| Yttrium-90 | 2.67 | days | 2282 | 934 |
| Krypton-85 | 10.76 | years | 687 | 251 |
| Thulium-170 | 128.6 | days | 968 | 315 |
| Sulfur-35 | 87.2 | days | 167 | 48.6 |
| Promethium-147 | 2.6234 | years | 22 | 62 |

Other beta-emitting radioisotopes that may be employed in the methods and devices of the present invention include, but are not limited to, erbium-169, phosphorus-33, tungsten-185, ruthenium-106 and strontium-90.

Preferably, the beta-emitting radioisotope emits an average beta energy of from about 20 keV to about 4000 keV, more preferably, the beta-emitting radioisotope emits an average beta energy of from about 50 keV to about 2500 keV, and, most preferably the average beta energy emitted by the beta-emitting isotope is from about 100 to about 1000 keV.

The half-life of the beta-emitting radioisotope is preferably less than about 200 days, for brachytherapy applications, and more preferably, less than about 150 days for brachytherapy applications, since it is often desirable that the radioisotope decay to a low level of radiation emission within a reasonable time period to allow for disposal of the brachytherapy device or for permanent implantation of the brachytherapy device in the body. For other applications, such as power generation or repeatedly used brachytherapy devices, longer half-life beta emitters may be desirable. For example, a beta-emitter such as krypton-85 with a half-life of 10.76 years can be employed for power generation over an extended time period.

The beta-emitter may be provided in any suitable manner including by production in a cyclotron, via neutron irradiation, via extraction from natural sources, via decay of another isotope to a beta-emitter, etc. In some cases, it may be desirable to include a precursor of a beta emitter in the device of the present invention, in place of, or in addition to, the beta emitter. In this manner, the device of the present invention may remain dormant, i.e. not emit radiation, until the precursor material is converted to a beta emitter by, for example, neutron irradiation, or some other external application of energy or radiation. This would permit the device to be shipped to distant locations or to be stored prior to use, if desired.

A variation of this concept is that the device of the present invention can be composed of a converter material, a beta emitter and a shielding device for shielding the converter material from the beta emitter. To generate characteristic radiation, beta radiation may be periodically or intermittently impinged on the converter material by removing or opening the shielding device. In this manner, characteristic radiation such as x-rays can be generated on a periodic basis, as needed, while at the same time providing a device that, when not generating characteristic radiation, does not emit any radiation to the surrounding environment. Suitable shielding would consist of low atomic numbered material.

The converter material can be any pure element, isotope, alloy, chemical compound, composition, or mixture of any physical form. The converter material should preferably have an atomic number value exceeding 1, more preferably, having an atomic number value exceeding 39, and, most preferably, having an atomic number value exceeding 46.

Exemplary converter materials include, but are not limited to, thulium, bismuth, silver, tin, zirconium, niobium, molybdenum, rhodium, palladium, hafnium, tungsten and gold.

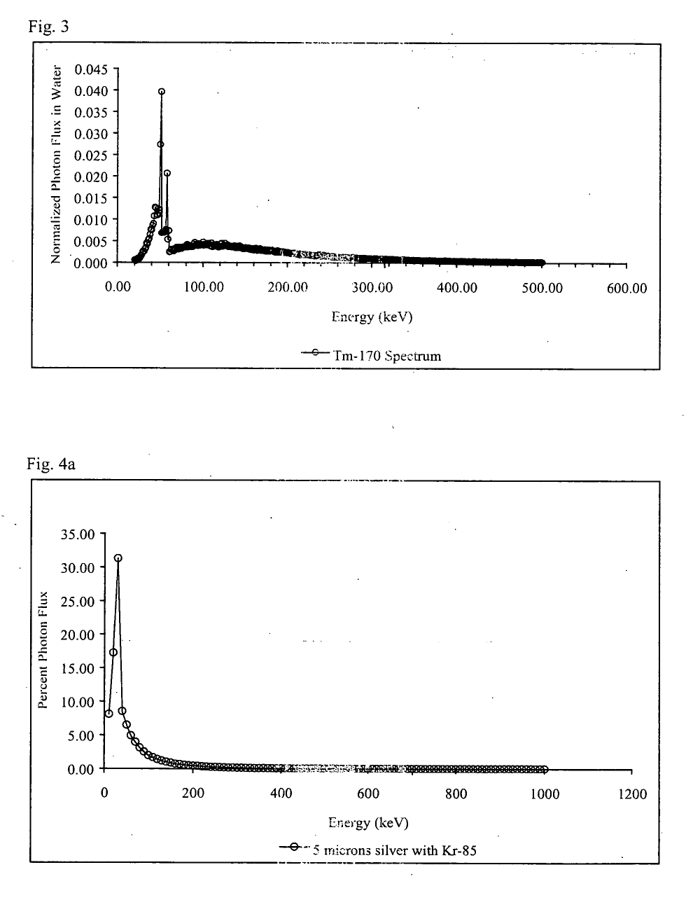

In some instances the beta emitter may also function as the converter material. One such material is the radioisotope thulium-170, which is a mid-energy beta emitter with a maximum beta energy of 968 keV and an average energy of ˜315 keV. In addition to a 128.6 day half-life, the K-shell x-ray emission of thulium-170 of ˜50 keV makes it an attractive candidate for medical high does rate (HDR) brachytherapy applications, such as the treatment of tumors, vascular disorders, and other ailments. FIG. 3 shows a mathematically modeled thulim-170 energy spectrum in water 3.5 cm from the source. Bremsstrahlung is at a much lower intensity in the spectrum, as compared to the amount of characteristic radiation found at 50 keV. The beta-emitting characteristics of thulium-170 interact with electrons in the K shell of the thulium-170 in order to create characteristic radiation. This enables a user of a brachytherapy device using thulium-170 to take advantage of the relatively long half-life of thulium-170 as a beta emitter, while at the same time generating radiation having an energy suitable for medical high dose rate brachytherapy.

In another embodiment, the characteristic radiation generator of the present invention may be combined with one or more radioisotopes to together form a radiation-emitting device. There may be instances, for example, where geometry or other factors place design constraints on the device such that insufficient radiation is generated by the characteristic radiation generator, taken alone. In such cases, a supplemental radiation source, which may be any suitable radioisotope, can be added to the radiation generator to provide additional radiation within the design constraints.

The beta-emitter and the converter material must be associated in a manner whereby the beta radiation impinges on the converter material with sufficient energy to eject one or more electrons from the converter material, to thereby initiate the process of generating characteristic radiation. Thus, for example, the beta-emitter and converter may be proximate to each other, optionally separated by one or more other materials that transmit beta radiation, adjacent to one another, in direct contact with one another, or combined together as a mixture, in a matrix or similar arrangement. Also, it is possible to arrange the beta-emitter within the converter material, around the converter material, atop the converter material or under the converter material, thereby permitting specialized configurations to be developed for use in specific applications of the device of the invention. Thus, it is not necessary to provide additional structure in the device of the present invention, such as a diffusion barrier, between or around the beta emitter and/or converter material.

An advantage of inducing characteristic radiation production is the ability to customize the energy spectrum of the emitted radiation. For example, in some applications it may be desirable to mimic the energy spectrum of a short lived photon-emitting isotope in order to provide a desirable energy spectrum of the emitted radiation, while at the same time achieving a more long-lived radiation emitter. This can be illustrated with Pd-103. Pd-103 emits ˜20 keV and ˜22.2 keV x-rays via electron capture, but only has a half-life of ˜16.97 days and emits some undesirable gamma radiation. However, combining a longer lived beta-emitter with silver, which has a K-shell energy of ˜22.2 keV, will provide nearly the same energy spectrum as palladium-103, with a significantly longer life, since the life of the characteristic radiation generator is dictated by the half-life of the beta-emitter employed, but without the associated gamma radiation. Therefore, a longer lived high-energy radiation source for use in brachytherapy can be created, while at the same time providing a reduction in undesirable deleterious radiation normally associated with the radioactive beta-emitting isotope that would produce the same energy spectrum of radiation.

Another advantage of the device of the present invention is that it permits optimization of the energy spectrum of the emitted characteristic radiation through a variety of means. For example, selection of a converter material that emits characteristic radiation at a particular energy level can be used to obtain the desired energy level of the emitted radiation, as explained above. Also, the geometry and density of the converter material can be manipulated to customize the quantity, energy and types of radiation emitted by the converter material. As a result, it is possible via selection of the converter material and manipulation of the geometry and/or density of the converter material, to produce a highly desirable characteristic radiation spectrum that is substantially free of undesirable radiation, such as bremsstrahlung.

With regard to the geometry of the converter material, it can be seen from the examples given below that it is possible by, for example, optimizing the thickness of the converter material, to maximize the desired emissions, while at the same time minimizing undesirable emissions.

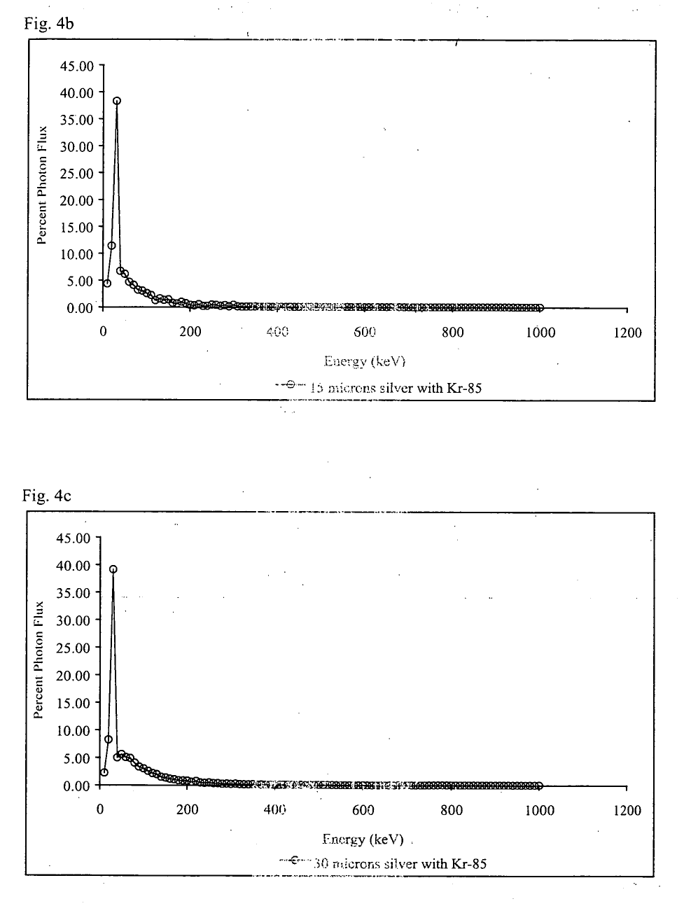

More specifically, FIGS. 4a-4g, show the normalized flux of characteristic radiation grouped by energy for a mathematical model of a krypton-85 beta-emitting source and an elemental silver converter material. As shown, an optimal thickness exists where the characteristic radiation flux is maximized without the creation of a substantial bremsstrahlung spectrum (e.g. FIGS. 4b-4d). As the thickness of the silver target increases, the amount characteristic radiation emitted decreases while the amount of emitted bremsstrahlung radiation increases. Therefore it is possible to optimize the thickness of the converter material in order to maximize the amount of characteristic radiation produced.

FIGS. 4a-4d show relatively high peaks for the characteristic radiation and little to no bremsstrahlung radiation produced. As the thickness of the silver is increased from 100 microns to 500 microns shown in FIGS. 4d and 4e, the amount of bremsstrahlung radiation increases significantly while the characteristic radiation begins to decrease. In FIG. 4g, when the silver is 2000 microns thick the characteristic radiation has significantly dropped. It is therefore important to provide a converter material with an appropriate thickness. In this regard, for brachytherapy applications, it is desirable to optimize the thickness of the converter material to ensure that a substantial proportion of the emitted radiation is the desired characteristic radiation emission. By a substantial proportion, is meant that at least 40% of the emitted radiation should be characteristic radiation, more preferably, at least 60% of the emitted radiation should be characteristic radiation, and, most preferably, at least 80% of the emitted radiation should be characteristic radiation.

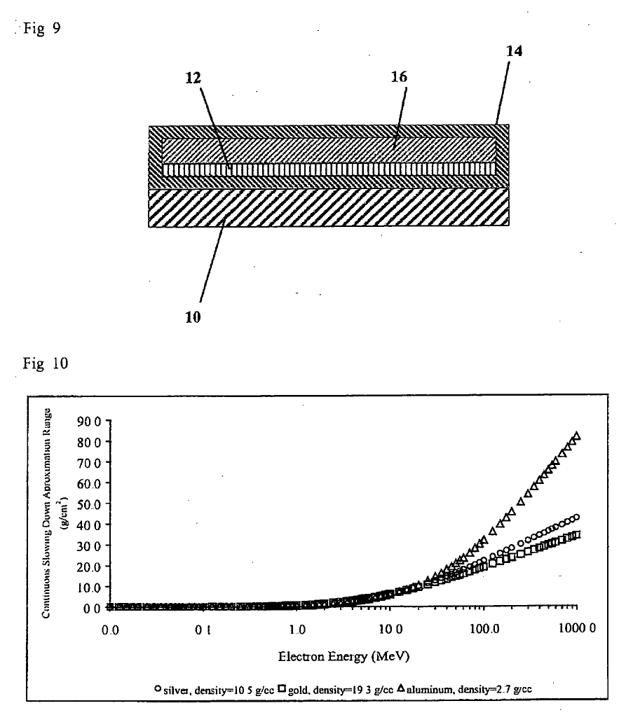

The range of the beta radiation is independent of the material density for electron energies between 0.01 MeV and 10 MeV, as shown by the example in FIG. 10. However, the range for electrons depends on the energy of the impinging electrons and the ratio of the atomic number (Z) to the mass number (A) of the target material (Z/A). For example, the range of a 1 MeV beta particle in aluminum is 0.555 g/cm² (Z/A=0.48, density=2.7 g/cm³), in silver 0.690 g/cm² (Z/A=0.44, density=10.5 g/cm³) and in gold 0.776 g/cm² (Z/A=0.40, density=19.3 g/cm³). The converter material should be sufficiently thick so that at least some of the beta radiation passing through the material interacts with the material and ejects an electron thereby producing characteristic radiation. If the converter material is too thick and/or dense, transmission of the characteristic radiation may be hampered, resulting in sub-optimal performance of the device.

In a preferred embodiment of the invention, the converter material forms the outer surface of the device since this will place the characteristic radiation emitter in close proximity to the treatment area or recipient of the characteristic radiation. In some embodiments of the invention, particularly brachytherapy applications involving contact between the patient and the device of the present invention, it may be desirable to provide an optional sealing layer as part of the device. The purpose of the optional sealing layer is to prevent contact between the beta emitter and the patient to thereby minimize the potential for the beta emitter to migrate from the device of the invention into the body. The optional sealing layer may be applied over the beta-emitter to provide a sealed source since some government regulations may require use of a sealed source for various reasons. This sealing layer may also act as a barrier to prevent emitted beta particles with ranges further than the thickness of the converter material, in the material of the converter, from interacting with tissue, if additional dose from the beta radiation is undesirable. Alternatively, the converter material can, in many instances, form a sealing layer around the beta emitter. In another embodiment, the sealing layer is applied around both the beta emitter and the converter material.

The sealing layer should preferably be a continuous layer that substantially prevents contact between the beta emitter and anything that may contact the outer surface of the device of the present invention. Thus, depending upon the placement of the sealing layer in the device, different properties of the sealing layer may be desirable. For example, a sealing layer that forms the outer surface of the device of the invention for use in brachytherapy should preferably be biocompatible, and may optionally be biodegradable, as long as the biodegradation is sufficiently slow that the sealing layer remains functional for a period sufficient to allow the beta emitter to decay to a relatively low emission level. The outer surface sealing layer should also be made of a material that transmits a substantial portion of the characteristic radiation emitted by the converter material. A sealing layer placed between the beta emitter and the converter material should transmit a substantial portion of the beta radiation emitted by the beta emitter and may also optionally be biocompatible and/or biodegradable. In this embodiment, it may be desirable to select a sealing layer that reduces transmission of, or scatters, at least some of the characteristic radiation emitted by the converter material.

Suitable biocompatible sealing materials can include films or coatings of polymers such as polyolefins, acrylates, polyurethanes, polyamides, polyimides, polyesters, polyvinyl chloride, cellulose esters, polysulfones, cyanoacrylates, modified versions of any of these materials and mixtures thereof. Alternatively, the biocompatible materials can be biocompatible metals such as titanium, stainless steel, tantalum, platinum, palladium or gold. Such biocompatible materials can be applied to the substrate containing radioactive material using any method known in the art. Of course, the self-shielding properties of such materials should be taken into consideration and minimized or at least equalized over the entire substrate, where possible.

As a practical matter, it may be desirable in some embodiments of the present invention to include a substrate in addition to the beta emitter and converter material. For example, in certain embodiments, it may be desirable to provide the beta emitter and/or converter material in a specific geometric configuration or relationship. In order to achieve this goal, it may be useful to employ a substrate material to create the desired geometric configuration or relationship. For example, for economic reasons, it may be desirable to provide the beta emitter and converter material as concentric thin layers in the device of the invention. A practical way of achieving this is to provide a substrate core upon which the layers of beta emitter and/or converter material can be immobilized.

Preferably, the beta emitter is associated with the substrate material in some way. For example, the beta emitter may be bonded to the outer surface of the substrate material or may be incorporated into the substrate material. In the latter case, the beta emitter may be incorporated throughout the substrate material or in only a portion of the substrate material, such as an outermost portion of the substrate material.

The substrate can be formed from a non-toxic metallic, non-metallic, polymeric, or ceramic material. The substrate can be in the form of a fiber, strand, ribbon, mesh, patch, film, suture, staple, clip, pin, microsphere, pellet, or the like. By pellet is meant substrates including, but not limited to, rods, cylinders and hollow tubes of different cross-sectional configurations. Further, the substrate can be rigid, flexible, deformable, solid, hollow, porous, or even sufficiently porous to allow for tissue growth therein.

In one embodiment, the substrate can be a thin film, fiber, ribbon, mesh, patch, suture, strand or the like formed from a biocompatible polymeric material. The polymeric material is preferably selected from the group consisting of polyvinyl chloride, polysulfones, cellulose esters, nylon, Dacron™, polyesters, polyolefins, polyurethanes, polyamides, polyimides and modified versions of one or more of these materials, as well as any other polymeric materials known by a skilled person to be suitable for this purpose.

Radiation can cause degradation of certain polymeric materials, as is known in the art. Particularly preferred polymeric materials for forming the substrate are polymeric materials, which are resistant to such degradation due to exposure to radiation, such as the radiation stabilized polypropylene materials disclosed in U.S. Pat. Nos. 5,122,593 and 5,140,073, the disclosures of which patents are hereby incorporated by reference to the extent that they relate to radiation stabilized polymeric materials suitable for use as substrates in the present invention.

Optionally, the polymeric materials forming the substrate can include one or more additives to enhance the adherence of the radiation source material to the substrate. Examples of such additives include absorbent materials such as activated carbon powder, activated charcoal, and ion exchange resins. Suitable ion exchange resins include sulfonated polystyrene resins, methylene-sulfonic phenolic resins, phosphoric polystyrene resins, polystyrene resins containing quaternary ammonium groups, pyridinium polystyrene resins, epoxy-polyamine resins containing tertiary and quaternary ammonium groups, acrylic resins, iminodiacetic polystyrene resins, and polystyrene resins containing polyamine groups, as well as other ion exchange resins known to persons skilled in the art.

In yet another embodiment, the substrate can be formed from a biodegradable polymeric material such as polyethylene glycol or polyethylene glycol-polyethylene oxide block copolymer. A particularly preferred substrate is made from a flexible or deformable material such as an elastomer, gel, foam or other suitable, flexible polymer material. Exemplary, but not limiting, polymeric materials include polyurethanes, silicones and elastomers, gels or foams of polyurethanes and silicones. Again, the key properties for use of these materials are that they must be suitable for implantation in the body and exhibit good radiation stability.

In an alternative embodiment, the substrate is a metallic material, which may be in the form of a pellet, or microsphere. The pellets or microspheres are preferably formed from a high atomic number metal or alloy such as iridium, platinum, gold, tantalum, tungsten, lead and alloys of one or more of these or similar metals. Additionally, any lower atomic weight metal or alloy, which is satisfactorily visualized on radiographs may be used including aluminum, molybdenum, indium, lithium, silver, copper, and stainless steel. Alternatively, when only magnetic resonance imaging of the delivery device is clinically desirable, the substrate can be a non-metallic pellet or microsphere formed from, for instance, carbon, diamond, or graphite or non-magnetic metals such as aluminum. In yet another embodiment, the substrate may be a combination of a non-metallic pellet or microsphere, and a metallic surface coating, which may serve as a primer to enhance adhesion of the beta emitter and/or converter material to the substrate.

The pellets or microspheres can be of any desired shape, but are preferably spherical or cylindrical. Of these substrates, graphite in the form of cylindrical pellets or microspheres is particularly preferred. In another alternative embodiment, the beta emitter and/or converter material further comprises a diluent. Suitable diluents may include palladium metal, rhodium metal, one or more of the various substrate materials listed above, or any other suitable material which is compatible with the radiation released by the beta emitter and/or converter material. More preferred diluents are biocompatible materials. Preferred diluents may be in the form of a soluble metal salt such as PdCl₂. Other preferred diluents are certain polymeric materials which can be employed as a diluent by, for example, homogeneously mixing the radiation source material with the polymer prior to its application to the substrate, or even by carrying out such mixing and using the mixture of polymeric material and radiation source material as the substrate itself.

Although the diluent may normally be considered an undesirable additive in a low energy emitting radiation source due to self-shielding effects, its addition in accordance with the present invention has been found to be advantageous in several respects, which in some applications may make use of such a diluent desirable. Foremost, the added diluent can serve to promote strong adhesion of the beta emitter and/or converter material to the substrate, thereby forming a physiologically inert layer which will not allow the material to be mobilized into the circulation of a patient being treated.

Secondly, the addition of diluent may provide the ability to adjust the specific activity of the material. This adjustment can be employed to provide an accurately determined desired level of therapeutic or apparent activity, as well as to compensate for the self-shielding effects of the diluent. The amount of diluent added, therefore, will vary. Preferably, from about 0.1 mg to about 100 mg of diluent per millicurie of radioactive material can be used. More preferably, from about 1 mg to about 50 mg of diluent per millicurie of radioactive source material is employed. Such amounts of diluent can ensure uniformity of the beta emitter and/or converter material in the device of the invention.

The amount of characteristic radiation emitted by the device, when employed in brachytherapy, depends primarily upon the therapeutic radiation dosage required. For instance, a specific activity of at least 2.5 Ci/g is usually desirable for therapeutic brachytherapy applications. The total radiation level emitted by the delivery device, i.e., the therapeutic activity, is more accurately expressed as an apparent value in mCi measured just outside the radiation delivery device which takes into account any self-shielding within the device which may occur, however minimal. By adjusting the converter material and the amount of the beta emitter incorporated into the device, the therapeutic activity level of the delivery device can be adjusted to preferred apparent activity levels of from about 0.5 mCi to about 300 Ci per device, and more preferably from about 0.5 mCi to about 30 Ci per device is employed.

In another embodiment of the present invention, the radiation delivery devices can be fabricated to provide a directional radiation distribution. More specifically, if a particular treatment demands that radiation need only be directed towards a particular location, it may be advantageous to fabricate a directional radiation delivery device, which can be employed to selectively irradiate neighboring tissue without irradiating other neighboring tissue. Also, directional devices may be useful in other applications, such as power generation, particularly if a special configuration of the device is desirable for interfacing with an associated system.

Directional devices can be made in at least two ways, selectively shielding a part of the device or controlling the location of the converter material relative to the substrate. In the first alternative, the device may be selectively shielded at predetermined locations to provide for non-uniform, i.e., directional radiation distribution. Such selective shielding can be accomplished by the incorporation of a shielding component into the device at one or more predetermined locations or by fabricating all or a portion of the substrate from a shielding material. Shielding components can include radiation-absorbing materials such as tin, silver, platinum, gold, tungsten, stainless steel, lead, brass, copper, or alloys thereof. More preferably, biocompatible shielding components are employed. The various embodiments of the flexible or deformable radiation delivery devices described herein can be directly adhered or attached to a shielding substrate in any suitable manner in order to provide a directional device.

Alternatively, directional radiation distributions can be accomplished by controlling the location of the converter material in or on the substrate and/or the location of the substrate in the overall delivery device. For example, the converter material may be applied to only one side of a substrate. This can be effectuated by providing some type of shielding material as the substrate, incorporating a shielding material into the substrate or even by providing a relatively large substrate such that radiation from the converter material has to travel a larger distance in one direction than another direction to leave the device. Since the effect of the characteristic radiation may be inversely proportional to the distance traveled by the radiation, a significant decrease in the exposure level of adjacent body tissue can be achieved merely by requiring the radiation to traverse such a distance or vary the attenuation on the surface of the device by providing a variation in the relative amounts of shielding. Alternatively, the depth at which the converter material is located within the substrate can be varied in order to vary the attenuation of the radiation and thereby give the desired directional effect to the device. The characteristic radiation field created by the converter can also be customized by shaping the area of the converter, while shielding any exposed portions of the beta emitter located on the substrate.

Optionally, the radiation delivery devices of the present invention can further include a marker to enhance imaging of the delivery devices once inside the body. The marker is generally comprised of a high atomic number element, which as a result of its high atomic number is X-ray opaque. Suitable examples of such elements are known to persons skilled in the art and include lead, barium, gold, tungsten, cobalt, platinum and rhodium. The marker can also be fabricated in a way that the orientation of the device, if significant, can be determined from the orientation of the marker in an x-ray, i.e. by providing a non-symmetrical marker having a known orientation relative to the radiation delivery device. This type of marker is particularly useful for the directional radiation delivery devices of the present invention.

The devices of the present invention may be fabricated in any conventional manner. Some examples of suitable fabrication techniques are disclosed, for example, in U.S. Pat. Nos. 6,749,553 and 6,666,811, the disclosures of which are hereby incorporated by reference for the purpose of disclosing suitable fabrication techniques for making the devices of the present invention.

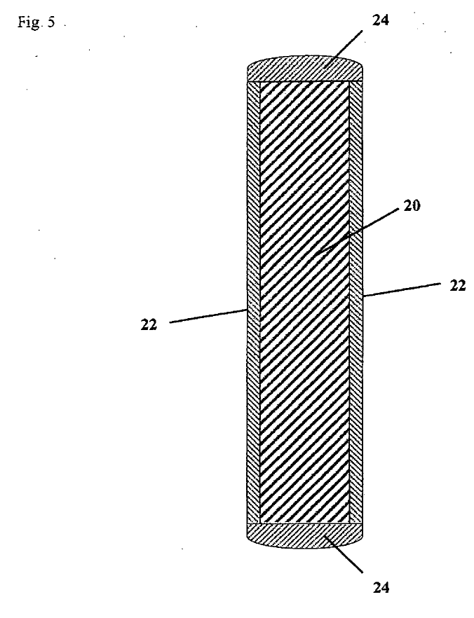

FIG. 7b shows an example of a device in accordance with the present invention. The device includes a substrate 40, a beta-emitting layer 42 on the substrate, a converter material 44 on the beta-emitting layer 42, and a sealing layer 46 on the converter material 44. In this embodiment, the beta-emitting layer 42 may be a substantially pure beta-emitter, or a mixture of a beta-emitter and one or more substrate materials. Alternatively, beta-emitting layer 42 may be a portion of substrate 40 in which beta-emitting material has been incorporated. Similarly, the converter material 44 may be substantially pure converter material; a mixture of converter material and substrate material or the layer 44 of converter material may be a portion of substrate 40 in which converter material has been incorporated.

In the brachytherapy method of the present invention, a device in accordance with the present invention is employed to emit characteristic radiation suitable for use in brachytherapy. The method involves the step of contacting a converter material with beta radiation to cause emission of characteristic radiation from the converter material. The method may also involve the step of emitting beta radiation from a beta emitter.

In another embodiment, the method of the present invention may further include the step of activating the beta emitter. In this embodiment, a precursor material may be provided instead of a beta emitter, the precursor material being such that at least some of the precursor material can be converted to a beta emitting material in some manner. Thus, for example, it may be possible to provide a precursor material that converts to a beta emitter when exposed to an external source of energy or radiation, to thereby activate the beta emitter of the device of the present invention. Since there is a substantial amount of radiation in space, it may be possible to provide a material that uses the radiation in space to slowly create a beta emitter to act as the beta source for the device of the present invention.

In brachytherapy, the method may involve the step of positioning the device of the invention proximate to a treatment area to thereby irradiate the treatment area with characteristic radiation. Positioning can be accomplished in any conventional manner such as by implantation, or other methodologies known to persons skilled in brachytherapy.

Various methods of the present invention may also be employed using a device that includes a means for shielding the converter material from the beta radiation emitted by the beta emitter or a means for separating the beta emitter from the converter material. In this method, characteristic radiation is generated on demand, periodically or intermittently, by selectively removing and replacing the shielding material and/or the beta emitter to thereby selectively contact the converter material with beta radiation. In this manner, the device can be turned on and off, at will.

Another application of the device of the present invention is the provision of power, such as electricity, using, for example, a photovoltaic cell, semiconductor or the provision of heat using another energy conversion device. A long-lived beta emitter and an appropriate converter material can be used to generate photons of an energy that can be converted by an energy conversion device to another form of energy, such as heat or electricity. In an optimized embodiment, the characteristic radiation emitted by the device of the invention targets the energy at which the maximum efficiency of the energy conversion device is realized, for example 15-50 keV when using GaAs. Other photovoltaic materials can also be used. Such materials, include, but are not limited to, silicon and InP.

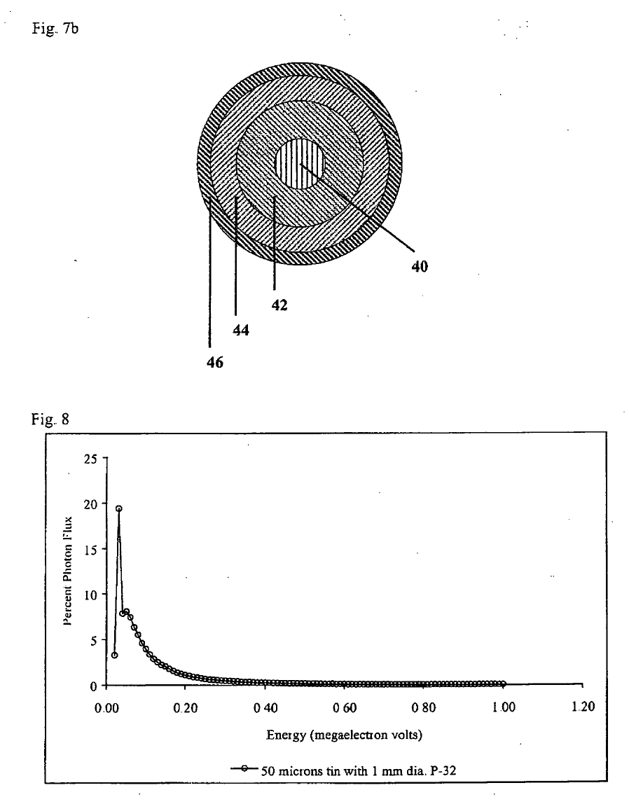

Another example of an energy conversion device is shown in FIG. 9. FIG. 9 shows a beta-emitting source material 16, and a converter material 12. In this example, the converter material is silver and the beta source isthallium-204. The device is placed within protective container 14 which can be constructed of a material such as titanium. This container prevents the source material from leaking, and protects the photovoltaic cell from potential damage by the beta particles that may have ranges further than the thickness of the converter, in the material of the converter. A photovoltaic cell 10 is then situated proximate to the converter material 14. Photovoltaic cell 10 converts the characteristic radiation generated by the converter material 14 into electricity, which can be used for a variety of electrically powered devices, such as medical devices, satellites, lighting, etc.

In another embodiment of the electricity generating apparatus, a scintillator may be employed. A scintillator crystal is a crystal which is transparent in the scintillation wavelength range which responds to incident radiation by emitting a light pulse. Scintillator crystals are widely used in detectors for gamma-ray, X-rays, cosmic rays and particles whose energy is of the order of 1 keV and greater. One embodiment of the present generation of scintillators comprises oxide mixtures in which a rare earth oxide is present as an activator, along with various combined matrix elements which are also usually rare earth oxides. Other combined metals may also be present as additives for specific purposes. These scintillators have been characterized by the advantageous properties of high efficiency, moderate decay time, low afterglow and little or no radiation damage upon exposure to high X-ray doses.

A family of known scintillator crystals widely used is of the thallium-doped sodium iodide, or NaI:T1, type. Another family of scintillator crystals is of the barium fluoride (BaF₂) type. Another family of scintillator crystals which has undergone considerable development is of the bismuth germanate (BGO) type. Another family of scintillator crystals is of the cerium-activated gadolinium orthosilicate (GSO) type. Another family of scintillators is of the organic plastic type, typically polyvinyltoluene or xylene based. These scintillators may be loaded with high atomic numbered elements such as lead or tin to increase their response to incident X-ray or gamma-ray radiation.

The scintillator material can be interposed between the radioisotope and the photovoltaic cell such that the radiation impinges on the scintillator which, in turn, emits a light pulse onto the photovoltaic cell. This may provide energy conversion efficiencies when certain combinations of materials are employed.

The embodiment wherein the beta emitter can be shielded and/or selectively separated from the converter material may be advantageous in the field of power generation, particularly when power is only required periodically, intermittently or on demand.

The present invention also relates to a method for the generation of heat or electricity including the steps of contacting a converter material with beta radiation to cause said converter material to emit characteristic radiation, and converting the emitted characteristic radiation to heat or electrical energy. In another embodiment, the method of the present invention may further include the step of activating the beta emitter.

Provided now are example applications for generating characteristic radiation with a beta-emitting source and converter.

### EXAMPLE 1

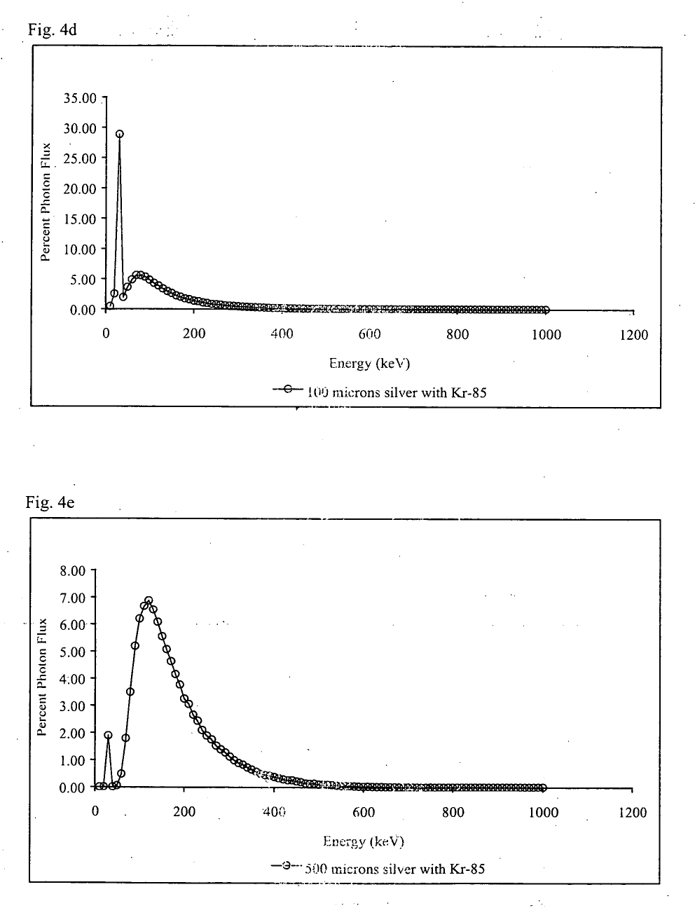

As shown in FIG. 5, a thulium-170 (Tm-170) high dose rate (HDR) device consists of a Tm-170 oxide cylindrical pellet 20, which is 1 mm in diameter and 5 mm long, with a mass of approximately 0.03377 grams encased in a close-fitted titanium tube 22 with a wall thickness of 0.006 cm and sealed with a titanium plug 24 on each end. The Tm-170 emits a spectrum of beta particles with average beta energy of 315 keV, and maximum beta energy of 968 keV; the half-life of Tm-170 is 128.6 days. A gamma ray of 84.3 keV with an intensity of 2.5% is also emitted as a result of the beta decay.

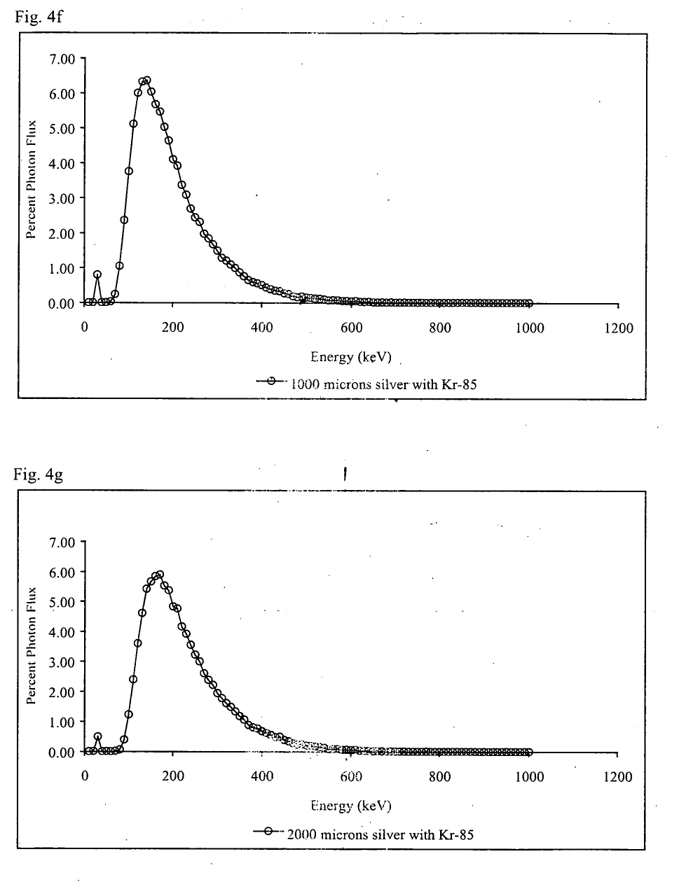

A dose rate constant of 1.17×10⁻³ gray/curie-minute (Gy/Ci-min) at 2 cm in water from the characteristic radiation and a dose rate constant of 1.99×10⁻⁴ Gy/Ci-min at 2 cm from the gamma ray can be calculated from the source centerline using Monte Carlo simulations. Analysis of the photon spectrum shows that 37% of the radiation is emitted between 40-70 keV, consistent with known characteristic x-ray data for Tm-170. The remainder of the spectrum consists of higher energy photons at low intensities, as shown in FIG. 6. Thulium-170 is an example of a self-converting source, i.e. the characteristic radiation provides a large portion of the isotope's photon spectrum.

If a dose of 3.4 Gy is to be delivered at 2 cm with the device described, it can be calculated that 2.9 Gy is a result of the characteristic radiation and 0.5 Gy results from the 84.3 keV gamma ray. Therefore, a dwell time of 35.8 minutes can be calculated to deliver 3.4 Gy for the given source activity of 69.4 Ci.

### EXAMPLE 2

A phosphorus-32/tin low does rate (LDR) device consists of a solid, 1 mm diameter sphere of P-32, with a mass of approximately 1.15 milligrams and a specific activity of 88.3 Ci/g, giving rise to a total activity of 100 millicuries (mCi). The P-32 is surrounded by a 50-micron thick spherical shell of elemental tin (Sn), which is in turn encapsulated by a 0.006 cm thick titanium spherical shell. Phosphorus-32 emits a spectrum of beta particles with average beta energy of 695 (keV) and maximum beta energy of 1710 keV, the half-life of P-32 is 14.28 days. FIG. 7A provides an illustration of the example device. The device of FIG. 7A includes a core 30 formed of a P-32 beta emitter, a layer of tin converter material 32 and a titanium sealing layer 34.

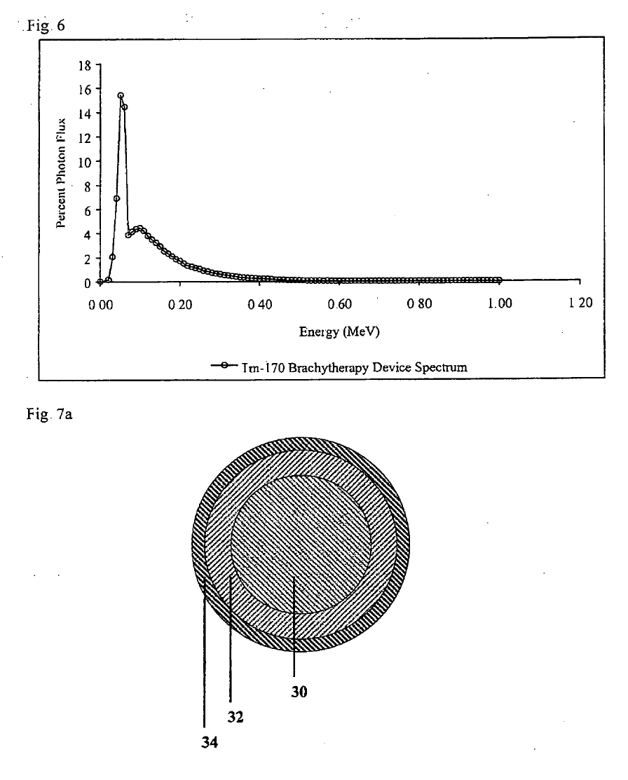

A dose rate constant of 8.7×10⁻³-gray/curie-minute (Gy/Ci-min) at 1 cm in water from the characteristic radiation created by the tin may be calculated from the source center using Monte Carlo simulations. Analysis of the photon spectrum shows that 19.39% of the radiation is emitted between 20-30 keV, consistent with known characteristic x-ray data for tin. The remainder of the spectrum consists of higher photons at low intensities, as shown in FIG. 8.

A progression of increasing thickness of the tin converter is illustrated in Table 1 to demonstrate the method for determining a configuration that optimizes the characteristic radiation output.

TABLE 1
Tin thickness effect on generated characteristic photon spectrum (percent of total flux shown).

| Energy Bin (keV) | 10 microns | 50 microns | 100 microns | 150 microns | 200 microns | 250 microns | 300 microns |
|---|---|---|---|---|---|---|---|
| 0-20 | 5.25 | 3.25 | 2.08 | 1.51 | 1.07 | 0.77 | 0.58 |
| 20-30 | 16.16 | 19.39 | 18.83 | 17.02 | 15.11 | 13.07 | 11.24 |
| 30-40 | 11.78 | 7.82 | 5.24 | 3.73 | 2.81 | 2.25 | 1.68 |
| 40-50 | 9.99 | 8.03 | 6.27 | 5.13 | 4.24 | 3.48 | 2.90 |
| 50-60 | 8.22 | 7.42 | 6.62 | 5.95 | 5.42 | 4.78 | 4.29 |
| 60-70 | 6.48 | 6.33 | 6.37 | 6.07 | 5.88 | 5.55 | 5.25 |
| 70-80 | 5.31 | 5.50 | 5.72 | 5.82 | 5.82 | 5.85 | 5.74 |
| 80-90 | 4.27 | 4.57 | 4.89 | 5.29 | 5.43 | 5.54 | 5.60 |
| 90-100 | 3.70 | 3.95 | 4.35 | 4.67 | 4.91 | 5.16 | 5.29 |
| 100-110 | 3.02 | 3.34 | 3.83 | 4.22 | 4.43 | 4.68 | 4.94 |
| 110-120 | 2.55 | 2.85 | 3.31 | 3.64 | 3.96 | 4.27 | 4.48 |
| 120-130 | 2.12 | 2.50 | 2.90 | 3.22 | 3.51 | 3.83 | 4.05 |
| 130-140 | 1.89 | 2.18 | 2.59 | 2.88 | 3.14 | 3.36 | 3.63 |
| 140-150 | 1.70 | 2.02 | 2.27 | 2.55 | 2.81 | 3.04 | 3.24 |
| 150-160 | 1.49 | 1.75 | 2.04 | 2.28 | 2.51 | 2.73 | 2.91 |
| 160-170 | 1.30 | 1.54 | 1.79 | 2.04 | 2.23 | 2.41 | 2.59 |
| 170-180 | 1.12 | 1.33 | 1.57 | 1.79 | 2.01 | 2.17 | 2.36 |
| 180-190 | 1.06 | 1.19 | 1.46 | 1.64 | 1.79 | 1.96 | 2.11 |
| 190-200 | 0.90 | 1.08 | 1.25 | 1.44 | 1.64 | 1.79 | 1.93 |
| 200-210 | 0.84 | 1.00 | 1.17 | 1.35 | 1.48 | 1.63 | 1.77 |
| 210-220 | 0.76 | 0.88 | 1.00 | 1.18 | 1.32 | 1.44 | 1.57 |
| 220-230 | 0.69 | 0.82 | 0.98 | 1.13 | 1.24 | 1.37 | 1.47 |
| 230-240 | 0.61 | 0.74 | 0.89 | 1.02 | 1.13 | 1.24 | 1.33 |
| 240-250 | 0.59 | 0.66 | 0.80 | 0.93 | 1.03 | 1.15 | 1.26 |
| 250-260 | 0.51 | 0.61 | 0.73 | 0.85 | 0.95 | 1.05 | 1.14 |
| 260-270 | 0.49 | 0.58 | 0.68 | 0.79 | 0.89 | 0.97 | 1.06 |
| 270-280 | 0.46 | 0.53 | 0.64 | 0.75 | 0.83 | 0.90 | 0.96 |
| 280-290 | 0.42 | 0.48 | 0.60 | 0.68 | 0.76 | 0.83 | 0.90 |
| 290-300 | 0.39 | 0.46 | 0.55 | 0.62 | 0.70 | 0.77 | 0.84 |

The total dose delivered over the life of the source is calculated as:

$${D}_{Total} = {\int }_{t = 0}^{t = ∞} \dot{D} {ⅇ}^{- λ t} ⅆ t = \frac{\dot{D}}{λ}$$

Dividing the dose rate constant (8.7×10⁻³ Gy/Ci-min) by the decay constant of P-32 (3.37×10⁻⁵ min⁻¹) gives a total dose per unit activity of 258.2 Gy/Ci. Therefore, a total dose of 25.82 Gy will be delivered by a permanent implant of this design. Adjusting the specific activity will allow the dose to be increased or decreased depending on the desired application.

It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

What is claimed is:

1. A radiation-emitting device comprising:
a radiation emitting material that emits beta radiation and converts at least a portion of said emitted beta radiation to characteristic radiation, and
a sealing layer bonded forming an outer surface of said device.

2. A radiation-emitting device as claimed in claim 1, wherein said radiation emitting material comprises thulium-170.

3. A radiation emitting device as claimed in claim 2, wherein said sealing layer comprises a material selected from the group consisting of polyolefins, acrylates, polyurethanes, polyamides, polyimides, polyesters, polyvinyl chloride, cellulose esters, polysulfones, cyanoacrylates, and mixtures thereof, titanium, stainless steel, tantalum, platinum, palladium and gold.

4. A radiation emitting device as claimed in claim 1, further comprising a substrate, and wherein said radiation emitting material is incorporated in, or bonded to, said substrate.

5. A radiation emitting device as claimed in claim 4, wherein said radiation emitting material is bonded to said substrate.

6. A radiation emitting device as claimed in claim 4, wherein said radiation emitting material is incorporated in said substrate.

7. A radiation emitting device as claimed in claim 6, wherein said radiation emitting material is incorporated in only a portion of said substrate.

8. A radiation emitting device comprising:
a beta radiation emitting material, and
a converter material associated with said beta radiation emitting material in a manner whereby at least some beta radiation emitted by said beta radiation emitting material contacts said converter material, said converter material converts at least some of said beta radiation to characteristic radiation, and
wherein at least 40% of the radiation emitted from said radiation emitting device is characteristic radiation.

9. The device of claim 8, wherein said beta radiation emitting material is selected from the group consisting of: thulium-170, thallium-204, phosphorus-32, strontium-89, krypton-85; sulfur-35, promethium-147, yttrium-90, erbium-169, phosphorus-33, tungsten-185, ruthenium-106, and strontium-90.

10. The device of claim 8, wherein said beta radiation emitting material is selected from the group consisting of: thulium-170, thallium-204, phosphorus-32, strontium-89, krypton-85, sulfur-35, promethium-147, yttrium-90.

11. The device of claim 8, wherein said converter material has an atomic number of at least 39.

12. The device of claim 8, wherein said converter material has an atomic number of at least 46.

13. The device of claim 8, wherein said converter material is selected from the group consisting of: silver, bismuth, thulium, tin, zirconium, niobium, molybdenum, rhodium, palladium, hafnium, tungsten, and gold.

14. The device of claim 8, wherein said converter material has a thickness that substantially minimizes emission of radiation other than characteristic radiation, from said device.

15. The device as claimed in claim 8, wherein said converter material is in contact with said beta radiation emitting material.

16. The device as claimed in claim 8, wherein said device does not include a diffusion barrier.

17. A radiation emitting device as claimed in claim 8, further comprising a sealing layer which forms an outer surface of the device.

18. A radiation emitting device as claimed in claim 17, wherein said sealing layer comprises a material selected from the group consisting of polyolefins, acrylates, polyurethanes, polyamides, polyimides, polyesters, polyvinyl chloride, cellulose esters, polysulfones, cyanoacrylates, and mixtures thereof, titanium, stainless steel, tantalum, platinum, palladium and gold.

19. A radiation emitting device as claimed in claim 8, further comprising a substrate, and wherein said radiation emitting material is incorporated in, or bonded to, said substrate.

20. A radiation emitting device as claimed in claim 19, wherein said radiation emitting material is bonded to said substrate.

21. A radiation emitting device as claimed in claim 19, wherein said radiation emitting material is incorporated in said substrate.

22. A radiation emitting device as claimed in claim 21, wherein said radiation emitting material is incorporated in only a portion of said substrate.

23. A radiation emitting device as claimed in claim 8, wherein the converter material further comprises a radioisotope of the converter material in addition to the converter material.

24. A radiation emitting device comprising:
a beta radiation emitting material, and
a converter material associated with said beta radiation emitting material in a manner whereby at least some beta radiation emitted by said beta radiation emitting material contacts said converter material, and
wherein said converter material converts at least some of said beta radiation to characteristic radiation, and said converter material forms at least a portion of an outer surface of said radiation emitting device.

25. The device of claim 24, wherein said beta radiation emitting material is selected from the group consisting of: thulium-170, thallium-204, phosphorus-32, strontium-89, krypton-85; sulfur-35, promethium-147, yttrium-90, erbium-169, phosphorus-33, tungsten-185, ruthenium-106, and strontium-90.

26. The device of claim 24, wherein said beta radiation emitting material is selected from the group consisting of: thulium-170, thallium-204, phosphorus-32, strontium-89, krypton-85; sulfur-35, promethium-147, yttrium-90.

27. The device of claim 24, wherein said converter material has an atomic number of at least 39.

28. The device of claim 24, wherein said converter material has an atomic number of at least 46.

29. The device of claim 24, wherein said converter material is selected from the group consisting of: silver, bismuth, thulium, tin, zirconium, niobium, molybdenum, rhodium, palladium, hafnium, tungsten and gold.

30. The device of claim 24, wherein said converter material has a thickness that substantially minimizes emission of radiation other than characteristic radiation, from said device.

31. The device as claimed in claim 24, wherein said converter material is in contact with said beta radiation emitting material.

32. The device as claimed in claim 24, wherein said device does not include a diffusion barrier.

33. A radiation emitting device as claimed in claim 24, further comprising a substrate, and wherein said radiation emitting material is incorporated in, or bonded to, said substrate.

34. A radiation emitting device as claimed in claim 33, wherein said radiation emitting material is bonded to said substrate.

35. A radiation emitting device as claimed in claim 33, wherein said radiation emitting material is incorporated in said substrate.

36. A radiation emitting device as claimed in claim 35, wherein said radiation emitting material is incorporated in only a portion of said substrate.

37. A radiation emitting device as claimed in claim 24, wherein the converter material further comprises a radioisotope of the converter material in addition to the converter material.

38. A heat or electricity producing device comprising:
a beta radiation emitting material,
a converter material associated with said beta radiation emitting material in a manner whereby at least some beta radiation emitted by said beta radiation emitting material contacts said converter material, said converter material converts at least some of said beta radiation to characteristic radiation, and
an energy conversion material, said energy conversion material converts at least some of said characteristic radiation to heat or electricity.
